(19) United States
(12) Patent Application Publication
(10) Pub. No.: US 2007/0133913 A1
(43) Pub. Date: Jun. 14, 2007

(54) Roller bearing having an eccentric outer ring

(76) Inventors: Hubert Heck, Dusseldorf (DE); Alexander Kiforluk, Ebersbach an der Fils (DE)

Correspondence Address: ROBERT W. BECKER & ASSOCIATES, 707 HIGHWAY 333, SUITE B, TIJERAS, NM, 87059-7507, US

(21) Appl. No.: 10/594,416

(22) PCT Filed: Feb. 23, 2005
(86) PCT No.: PCT/EP05/01884

§ 371 Date: Feb. 8, 2007

(30) Foreign Application Priority Data
Mar. 24, 2004 (DE) 10 2004 014 810.4

(51) Int. Cl. F16C 19/50

(52) U.S. Cl. 384/447

(57) ABSTRACT

A bearing comprising an outer ring that is provided with an inner annular bearing surface and an outer annular peripheral surface, wherein the peripheral surface is eccentric to the bearing surface and the bearing is a roller bearing.

With the mounting of shafts and during their operation, friction bearings are used, for example with printing machines, that are provided with an outer ring having an outer peripheral surface that is eccentric to the bearing surface. A bearing of this type is known, for example, from EP 0 076 789 A1. This bearing is used for rotating shafts. It is disadvantageous for a shaft that frequently comes to a stop, because friction bearings have a high starting torque. They furthermore basically require a continuous lubrication and monitoring during operation.

Corresponding bearings are not known for gear mechanism shafts, the direction of rotation of which frequently changes during operation, and which are maintenance-free over the service life of the gear mechanism.

It is therefore an object of the present invention to provide a suitable bearing, that is as maintenance-free as possible, for shafts, in particular for gear mechanism shafts having a frequently reversing direction of rotation.

This object is realized by a bearing having the features of claim 1.

Since the bearing is a roller bearing, bearings or mountings of shafts of the type described can be constructed such that during starting after a temporary stopping an increased friction does not occur.

The bearing can be a grooved ball bearing. With the mounting of gear mechanism shafts, it is preferably a radial grooved ball bearing.

The engagement of teeth in a gear mechanism can be adjusted particularly precisely if the bearing has an eccentricity in the range of from 10 μm to 200 μm.

The adjustment of the position of the outer ring is simplified if the outer ring is provided with recesses for the engagement of a tool, preferably at least two front holes that are oriented parallel to the axis of rotation, grooves, or the other recesses. Pursuant to another embodiment, projections such as pins or noses can be provided that are suitable for the engagement of a tool.

Similarly advantageous is the use of a bearing as described for the mounting of a gear mechanism shaft that is adjustable in a manner free of play.

One embodiment of the present invention will be described subsequently with the aid of the drawing, which shows:

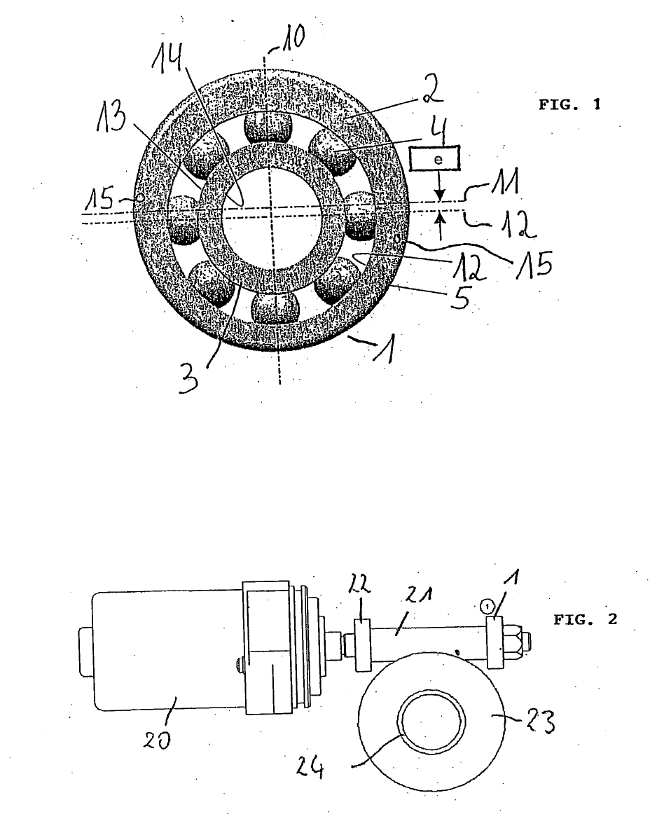

FIG. 1: a grooved ball bearing having an eccentric outer ring; and

FIG. 2: a gear mechanism having an electric motor and a worm drive that is adjusted in a manner free of play with a bearing according to FIG. 1.

FIG. 1 shows an inventive grooved ball bearing 1 having an outer ring 2 and an inner ring 3, between which are disposed bearing balls 4. The outer ring 2 has an outer, annular peripheral surface 5 that is rotationally symmetrical relative to the point of intersection of two axes 10 and 11. The outer ring 2 is furthermore provided with an inner peripheral surface 12 that is also annular but is rotationally symmetrical to the point of intersection of the axes 10 and 12. The outer peripheral surface 5 and the inner peripheral surface 12 are consequently eccentric relative to one another by an amount e that corresponds to the spacing or distance between the two aforementioned points of intersection 10, 11 or 10, 12 respectively.

The inner peripheral surface 12, the balls 4 that are uniformly distributed over the periphery, and the inner ring 3, which has an outer bearing surface 13 and an inner peripheral surface 14, are also rotationally symmetrical relative to the point of intersection of the axes 10 and 12, so that they form a radial grooved ball bearing.

The outer ring 2 furthermore has two recesses in the form of front holes 15 that are disposed diametrically across from one another on the end face of the outer ring 2 and which, perpendicular to the plane of the drawing sheet, are introduced into the outer ring 2 as blind holes.

A worm drive is schematically illustrated in FIG. 2. The worm drive is driven by an electric motor 20, the motor shaft of which carries a screw or worm 21. The worm 21 is rotatably mounted in a non-illustrated transmission housing in a conventional ball bearing 22 and an inventive ball bearing 1.

The worm 21 meshes with the worm gear 23, which is similarly mounted in the transmission housing via a ball bearing 24 and a corresponding second ball bearing on that side facing away from the observer.

With such gear mechanisms with intersecting shafts that are mounted in a common housing, an adjustment of the play between the worm 21 and the worm gear 23 has not been possible up to now. Therefore, such gear mechanisms have been manufactured in a manner largely free of play by selection of the intermeshing elements in an as exact a fit as possible. For this purpose, a measurement and classification of the worm 21 and the worm gear 23 are customary. This process is very complicated and does not always lead to an operation of the engagement that is completely free of play. However, an operation that is free of play is the cause of a disadvantageous development of noise, especially with gear mechanisms that frequently change the running direction.

In connection with the customary precision of manufacture, it is now possible with the use of the inventive bearing 1 to utilize every worm 21 with every worm gear 23 in a gear mechanism. During assembly, the eccentric ball bearing 1 is placed in a special seat of the transmission housing in which on the one hand it is accessible from that side facing away from the electric motor 20 (the right side in FIG. 2), and on the other hand is initially still rotatably seated via its outer ring 2. To adjust the play of the engagement between the worm 21 and the worm gear 23, a face spanner or wrench can now be inserted into the front holes 15, and the outer ring 2 can be rotated in the seat of the transmission housing. This rotation effects a slight change of position of the worm 21, and is carried out until either the measured play between the worm 21 and the worm gear 23 has the desired value, or until the friction that is to be determined by rotation of the worm 21 has reached a predetermined value in the engagement that indicates that the engagement is free of play. In this position, the outer ring 2 is fixed in its seat. This fixation can be effected by a clamp in the manner of a ring or collar that surrounds the bearing 1. However, the bearing 1 can also be inserted with an adhesive that initially remains liquid or pasty for the period of the adjustment process, and that after a suitable period of time hardens, thus fixing the bearing seat.

This particularly precise free-of-play adjustment of the described worm gear mechanism is possible for the first time by using the inventive bearing 1. In this connection, depending upon the application, the eccentricity e of the bearing 1 is, for example, in the range of between 10 μm and 200 μm.

The novel type of ball bearing can be used with particular advantage with a worm drive that is used with an electrical servo drive or a servo steering gear mechanism of a motor vehicle. With such steering gear mechanisms, when the vehicle is driving straight ahead, one must frequently take into consideration a state or condition in which only very slight steering deviations are effected. This oscillation about the neutral position is sensed in the gear mechanism in that only very small angles of rotation occur with frequently changing direction. In this operating state, even the slightest play between the two intermeshing components leads to the development of noise, which is undesired. This is eliminated with the inventive bearing 1 and the described use for the mounting in a worm drive.

1-7. (canceled)

8. A bearing comprising:
an outer ring, which is provided with an inner, annular bearing surface and an outer, annular peripheral surface, wherein said outer peripheral surface is eccentric to said inner bearing surface, and wherein the bearing is a roller bearing.

9. A bearing according to claim 8, wherein said bearing is a grooved ball bearing.

10. A bearing according to claim 9, wherein said bearing is a radial grooved ball bearing.

11. A bearing according to claim 8, wherein the eccentricity (e) is in a range of from 10 μm to 200 μpm.

12. A bearing according to claim 8, wherein said outer ring is provided with recesses for engagement by a tool.

13. A bearing according to claim 12, wherein said recesses of said outer ring are in the form of at least two front holes that are oriented parallel to an axis of rotation of the bearing.

14. The use of the bearing of claim 8, including the step of adjusting a position of a gear mechanism shaft for a meshing engagement in a manner substantially free of play.
